(19) United States
(12) Patent Application Publication
(10) Pub. No.: US 2021/0086766 A1
(43) Pub. Date: Mar. 25, 2021

(54) METHOD FOR EXECUTING A FUNCTION OF A MOTOR VEHICLE

(71) Applicant: Robert Bosch GmbH, Stuttgart (DE)

(72) Inventor: Stefan Nordbruch, Kornwestheim (DE)

(21) Appl. No.: 17/002,628

(22) Filed: Aug. 25, 2020

(30) Foreign Application Priority Data
Sep. 23, 2019 (DE) 102019214453.5

(51) Int. Cl. B60W 30/095; B60W 30/09; B60W 40/02; B60W 50/04; H04W 4/44; H04L 29/08

(52) U.S. Cl. CPC B60W 30/0956; B60W 30/09; B60W 40/02; B60W 2050/0077; H04W 4/44; H04L 67/12; B60W 50/04

(57) ABSTRACT

A method for the safe execution of a function provided by a motor vehicle. The method includes receiving infrastructure data signals, which represent infrastructure data, which are intended for a function provided by a motor vehicle, receiving safety condition signals, which represent at least one safety condition that must be fulfilled so that the function based on the infrastructure data may be executed, checking whether the at least one safety condition is fulfilled, ascertaining whether the function based on the infrastructure data may be executed, based on a result of the check, generating result signals, which represent a result of the ascertainment, and outputting the generated result signals. A device, a computer program and a machine-readable storage medium are also described.

### CROSS REFERENCE

The present application claims the benefit under 35 U.S.C. § 119 of German Patent Application No. DE 102019214453.5 filed on Sep. 23, 2019, which is expressly incorporated herein by reference in its entirety.

### FIELD

The present invention relates to a method for the safe execution of a function provided by a motor vehicle. The present invention further relates to a device, to a computer program and to a machine-readable storage medium.

### BACKGROUND INFORMATION

German Patent Application No. DE 10 2017 204 603 A1 describes a vehicle control system and a method for controlling a vehicle.

German Patent Application No. DE 10 2018 124 807 A1 describes a system and a method for operating a hybrid drive train of a vehicle.

German Patent Application No. DE 10 2017 212 227 A1 describes a method and a system for vehicle data collection and vehicle control in road traffic.

Motor vehicles, which use data from an infrastructure, use these data for example for warning functions, information functions and comfort functions.

When infrastructure data are used for executing a safety-critical function, for example an emergency braking function, it must be ensured that the infrastructure data were not manipulated, for example.

### SUMMARY

An object of the present invention is to provide for an efficient and safe execution of a function provided by a motor vehicle.

This objective is achieved by example embodiments of the present invention. Advantageous developments of the present invention are described herein.

According to a first aspect of the present invention, a method is provided for safely executing a function provided by a motor vehicle. In accordance with an example embodiment of the present invention, the method includes the following steps:

receiving infrastructure data signals, which represent infrastructure data, which are intended for a function provided by a motor vehicle,

receiving safety condition signals, which represent at least one safety condition that must be fulfilled so that the function based on the infrastructure data may be executed,

checking whether the at least one safety condition is fulfilled, ascertaining whether the function based on the infrastructure data may be executed, based on a result of the check,

generating result signals, which represent a result of the ascertainment,

outputting the generated result signals.

According to a second aspect of the present invention, a device is provided, which is designed to perform all steps of the method according to the first aspect.

According to a third aspect of the present invention, a computer program is provided, which comprises commands, which prompt a computer, for example the device according to the second aspect, when executing the computer program, to implement a method according to the first aspect.

According to a fourth aspect of the present invention, a machine-readable storage medium is provided, on which the computer program according to the third aspect is stored.

The present invention is based on the realization and includes this realization that before a function of a motor vehicle uses the infrastructure data, a check is performed to determine whether or not at least one safety condition is fulfilled. Based on this result, an ascertainment is then made to determine whether the function based on the infrastructure data may be executed. Depending on the result, corresponding result signals are then generated and output.

The function is then executed, or not, in particular based on the generated result signals, using the infrastructure data.

This makes it possible advantageously to ensure in an efficient manner that a safe environment is created when executing the function based on the infrastructure data. Via the safety condition, it is thus possible to specify and/or determine or define a context, within which a function of the motor vehicle based on the infrastructure data may be executed safely.

This yields in particular the technical advantage of minimizing or avoiding a risk for road users in the surroundings of the motor vehicle. This advantageously makes it possible to ensure in particular that a risk for the motor vehicle itself can be minimized or avoided.

In the sense of the description, “safe” means in particular “safe” and “secure.” These two English terms are normally translated into German as “sicker.” In English, however, they have in part a different meaning.

The term “safe” pertains in particular to the topic of accident and accident avoidance. An execution of a function based on the infrastructure data that is “safe” is one in which a probability of an accident or a collision is smaller than or smaller than/equal to a predetermined probability threshold value.

The term “secure” pertains in particular to the topic of computer protection and/or hacker protection, that is, in particular to how well a (computer) infrastructure and/or a communication infrastructure, in particular a communication link between a motor vehicle and a device according to the second aspect, is secured against unauthorized access and/or against data manipulations by third parties (“hackers”).

An execution of a function based on infrastructure data that is “secure” is thus in particular based on an appropriate and sufficient computer protection and/or hacker protection.

One specific embodiment of the present invention provides for the at least one safety condition to be respectively an element selected from the following group of safety conditions: existence of a predetermined safety integrity level (SIL) or automotive safety integrity level (ASIL) of at least the motor vehicle and the infrastructure, in particular including a communication link and/or communication components, in particular with respect to the overall systems in the motor vehicle and infrastructure and in particular parts, e.g., components, algorithms, interfaces, etc., existence of a maximum latency of a communication between the motor vehicle and the infrastructure, existence of a predetermined computer protection level of a device according to the second aspect, existence of predetermined components and/or algorithms and/or communication options that are used for performing the steps of the method according to the first aspect, existence of a redundancy and/or diversity in predetermined components and/or algorithms and/or communication options that are used for performing the steps of the method according to the first aspect, existence of predetermined availability information, which indicates an availability of predetermined components and/or algorithms and/or communication options, existence of predetermined quality criteria of the predetermined components and/or algorithms and/or communication options, existence of a plan which comprises measures for reducing errors and/or measures in the event of failures of predetermined components and/or algorithms and/or communication options and/or measures for misdiagnoses and/or measures in the event of misinterpretations, existence of one or multiple fallback scenarios, existence of a predetermined function, existence of a predetermined traffic situation existence of a predetermined weather, maximally possible time for a respective performance and/or execution of a step or of multiple steps of the method according to the first aspect, existence of a result of a check to determine that elements and/or functions, which are used for carrying out the method according to the first aspect, currently function in a faultless manner.

A communication link is for example a communication link between the device according to the second aspect and the motor vehicle. A communication link comprises for example one or multiple communication channels.

In one specific embodiment of the present invention, a component, which is used to carry out the method according to the first aspect, is an element selected from the following group of components: environment sensor, motor vehicle, infrastructure, device according to the second aspect, motor vehicle system, in particular drive system, clutch system, brake system, driver assistance system, communication interface of the motor vehicle and/or of the infrastructure, processor, input, output of the device according to the second aspect, control unit, in particular main control unit of the motor vehicle.

A computer protection level defines in particular the following: activated firewall and/or valid encryption certificate for encrypting a communication between the motor vehicle and the infrastructure and/or activated virus program having updated virus signatures and/or existence of a protection, in particular a mechanical protection, in particular a break-in protection, of the computer, in particular of the device according to the second aspect, and/or existence of a possibility for checking that signals, in particular infrastructure data signals, were transmitted correctly, that is, error-free.

An algorithm comprises for example the computer program according to the third aspect of the present invention.

The fact that in particular a check is performed to determine that there exists a redundancy and/or diversity in predetermined components and/or algorithms and/or communication options yields for example the technical advantage that even in the event of a failure of the respective component, for example a computer, and/or of the corresponding algorithm and/or of the corresponding communication option, it is nevertheless possible to execute a safe function.

To ensure that results are correct, it is possible in one specific embodiment of the present invention to calculate these results multiple times for example and to compare the respective results with one another. Only if there is agreement among the results is it determined for example that the results are correct. If multiple times is an uneven number, it may be provided for example that a determination is made that the result corresponding to the highest number of identical results is correct.

One specific embodiment of the present invention provides for the at least one safety condition to be selected as a function of a currently existing situation and/or as a function of a motor vehicle model and/or of a motor vehicle type of the motor vehicle and/or as a function of an infrastructure model and/or of an infrastructure type of the infrastructure and/or as a function of the function.

This yields for example the technical advantage of allowing the at least one safety condition to be selected efficiently.

One specific embodiment of the present invention provides for the ascertainment to be performed as a function of a currently existing situation and/or as a function of a motor vehicle model and/or of a motor vehicle type of the motor vehicle and/or as a function of an infrastructure model and/or of an infrastructure type of the infrastructure and/or as a function of the function.

This yields in particular the technical advantage of allowing the step of ascertaining to be performed efficiently.

One specific embodiment provides that, if the result indicates that the function based on the infrastructure data may be executed, the execution of the function based on the infrastructure data is monitored in that the steps of checking, of ascertaining and of outputting the generated result signals are performed anew, the function being executed further as a function of a newly ascertained result.

This yields in particular the technical advantage of allowing the execution of the function based on the infrastructure data to be monitored efficiently.

If the renewed check should yield the result for example that the at least one safety condition is no longer fulfilled, the execution of the function is aborted for example.

If the renewed check yields the result for example that the at least one safety condition continues to be fulfilled, the function continues to be executed for example.

One specific embodiment of the present invention provides for one or multiple method steps to be performed within the vehicle and/or one or multiple method steps to be performed outside the vehicle, in particular in the infrastructure and/or in particular in a cloud infrastructure.

This yields for example the technical advantage of allowing the corresponding method steps to be performed redundantly in an efficient manner. Advantageously, this may advantageously further increase a safety.

One specific embodiment of the present invention provides for one or multiple method steps to be documented, in particular documented in a blockchain.

This yields for example the technical advantage of allowing the method to be analyzed even after its implementation or execution, on the basis of the documentation. The documentation in a blockchain in particular has the technical advantage that the documentation is secured against manipulation and forgery.

A blockchain is a continuously expandable list of data sets, called “blocks”, which are linked to one another by one or multiple cryptographic methods. Each block contains in particular a cryptographically secure hash (erratic value) of the preceding block, in particular a time stamp and in particular transaction data.

One specific embodiment of the present invention provides for a check to be performed to determine whether a totality made up of the motor vehicle and of infrastructure involved in the method according to the first aspect including a communication between infrastructure and motor vehicle is secure so that the motor vehicle and/or a local and/or a global infrastructure and/or a communication between motor vehicle and infrastructure are checked accordingly.

This thus means in particular that the components used in the implementation of the method according to the first aspect are checked for safety, that is, whether they fulfill specific safety conditions, before the function using and/or based on the infrastructure data may be executed.

Important and/or dependent criteria are for example one or several of the safety conditions described previously.

One specific embodiment provides for the function to be an element selected from the following group of functions: emergency braking function, driving function for driving the motor vehicle in at least partially automated fashion, lighting assistance function, in particular high-beam assistance function, ESP function, ABS function, air bag function, drive planning function, traffic analysis function, brake function, drive function, in particular motor function, steering function.

This yields for example the technical advantage of allowing particularly suitable functions to be used.

One specific embodiment provides for the infrastructure data to comprise one or several elements selected from the following group of data: environment sensor data of an infrastructure environment sensor, surroundings data, which represent a surroundings of the motor vehicle, weather data, which represent a weather in a surroundings of the motor vehicle, traffic data, which represent a traffic in a surroundings of the motor vehicle, hazard data, which represent a location and/or a type of a hazard area in the surroundings of the motor vehicle, road user status data, which represent a status of a road user in the surroundings of the motor vehicle.

This yields for example the technical advantage of allowing the use of particularly suitable infrastructure data.

The formulation “driving in at least partially automated fashion” comprises one or several of the following cases: assisted driving, partially automated driving, highly automated driving, fully automated driving.

Assisted driving means that a driver of the motor vehicle permanently performs either the lateral or the longitudinal guidance of the motor vehicle. The respectively other driving task (that is, controlling the longitudinal or the lateral guidance of the motor vehicle) is performed automatically. That is to say that in assisted driving of the motor vehicle either the lateral guidance or the longitudinal guidance is controlled automatically.

Partially automated driving means that in a specific situation (for example: driving on a freeway, driving within a parking facility, passing an object, driving within a traffic lane, which is defined by lane markers) and/or for a certain time period a longitudinal guidance and a lateral guidance of the motor vehicle are controlled automatically. It is not necessary for a driver of the motor vehicle to control the longitudinal and lateral guidance of the motor vehicle manually. Nevertheless, the driver must permanently monitor the automatic control of the longitudinal and lateral guidance so as to be able to intervene manually when necessary. The driver must always be prepared to take complete control of driving the motor vehicle.

Highly automated driving means that for a certain time period in a specific situation (for example: driving on a freeway, driving within a parking facility, passing an object, driving within a traffic lane, which is defined by lane markers) a longitudinal guidance and a lateral guidance of the motor vehicle is controlled automatically. It is not necessary for a driver of the motor vehicle to control the longitudinal and lateral guidance of the motor vehicle manually. It is not necessary for the driver permanently to monitor the automatic control of the longitudinal and lateral guidance so as to be able to intervene manually when necessary. When necessary, a takeover request is automatically output to the driver for taking over the control of the longitudinal and lateral guidance, in particular with sufficient time to respond. Thus, the driver must be potentially able to take control of longitudinal and lateral guidance. Limits of the automatic control of the lateral and longitudinal guidance are detected automatically. In highly automated driving, it is not possible in every initial situation to bring about a risk-minimized state automatically.

Fully automated driving means that in a specific situation (for example: driving on a freeway, driving within a parking facility, passing an object, driving within a traffic lane, which is defined by lane markers) a longitudinal guidance and a lateral guidance of the motor vehicle are controlled automatically. It is not necessary for a driver of the motor vehicle to control the longitudinal and lateral guidance of the motor vehicle manually. It is not necessary for the driver to monitor the automatic control of the longitudinal and lateral guidance so as to be able to intervene manually when necessary. Prior to a termination of the automatic control of the lateral and longitudinal guidance, a request is automatically output to the driver to take over the task of driving (controlling the lateral and longitudinal guidance of the motor vehicle), in particular with sufficient time to respond. If the driver does not take over the task of driving, the motor vehicle is automatically returned to a risk-minimized state. Limits of the automatic control of the lateral and longitudinal guidance are detected automatically. In all situations it is possible to return the motor vehicle automatically to a risk-minimized system state.

In one specific embodiment of the present invention, the example method according to the first aspect comprises an execution of the function based on the infrastructure data.

One specific embodiment of the present invention provides for the example method according to the first aspect to be a computer-implemented method.

One specific embodiment of the present invention provides for the example method according to the first aspect to be carried out or implemented using the device according to the second aspect.

Device features result analogously from corresponding method features and vice versa. That is to say in particular that technical functions of the device according to the second aspect analogously result from corresponding technical functionalities of the method according to the first aspect and vice versa.

The formulation “at least one” stands in particular for “one or several.”

Exemplary embodiments of the present invention are illustrated in the figures and are explained in greater detail below.

### BRIEF DESCRIPTION OF THE DRAWINGS

FIG. 1 shows a flow chart of an example method for the safe execution of a function provided by a motor vehicle in accordance with the present invention.

FIG. 2 shows a device in accordance with an example embodiment of the present invention.

FIG. 3 shows a machine-readable storage medium in accordance with an example embodiment of the present invention.

FIG. 4 shows a motor vehicle in accordance with an example embodiment of the present invention.

FIG. 5 shows a table in accordance with an example embodiment of the present invention.

### DETAILED DESCRIPTION OF EXAMPLE EMBODIMENTS

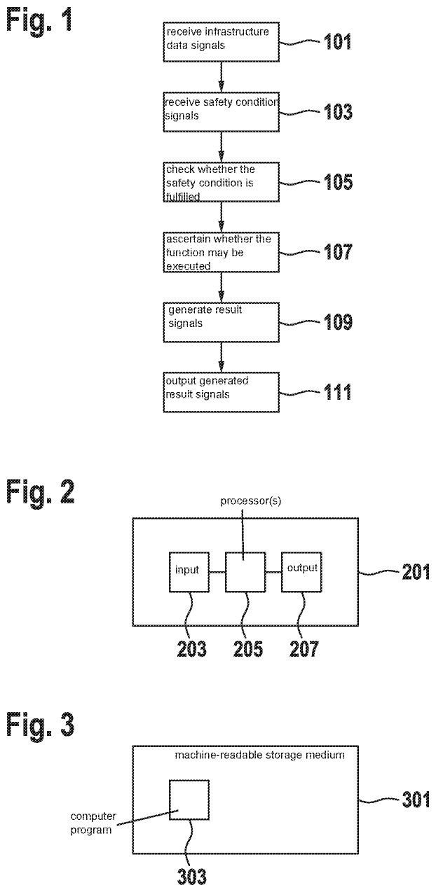

FIG. 1 shows a flow chart of a method for the safe execution of a function provided by a motor vehicle in accordance with an example embodiment of the present invention.

The example method comprises the following steps:

receiving 101 infrastructure data signals, which represent infrastructure data, which are intended for a function provided by a motor vehicle,

receiving 103 safety condition signals, which represent at least one safety condition that must be fulfilled so that the function based on the infrastructure data may be executed,

checking 105 whether the at least one safety condition is fulfilled,

ascertaining 107 whether the function based on the infrastructure data may be executed, based on a result of the check,

generating 109 result signals, which represent a result of the ascertainment,

outputting 111 the generated result signals.

The result of the check indicates for example whether or not the at least one safety condition is fulfilled.

There is a provision for example that the function based on the infrastructure data must not be executed if the result of the check indicates that the at least one safety condition is not fulfilled.

There is a provision for example that the function based on the infrastructure data may be executed if the result of the check indicates that the at least one safety condition is fulfilled.

That is to say in particular that the result of the ascertainment indicates in particular that the function based on the infrastructure data may be executed or must not be executed.

In one specific embodiment, the method according to the first aspect comprises an execution of the function based on the infrastructure data if the result of the ascertainment indicates that the function based on the infrastructure data may be executed.

FIG. 2 shows a device 201.

Device 201 is designed to perform all of the steps of the method according to the first aspect.

Device 201 comprises an input 201, which is designed to receive the infrastructure data signals and the safety condition signals.

Device 201 further comprises a processor 205, which is designed to perform and/or execute the steps of checking, of ascertaining and of generating.

Device 201 further comprises an output 207, which is designed to output the generated result signals.

Device 201 is for example part of a cloud infrastructure.

Device 201 is situated for example within the infrastructure.

Signals that are received are generally received via input 203. Input 203 is thus designed in particular to receive the respective signals.

Signals that are output are generally output via output 207. Output 207 is thus designed in particular to output the respective signals.

According to one specific embodiment, multiple processors are provided instead of the one processor 205.

One specific embodiment provides for processor 205 to be designed to execute the steps of checking and of ascertaining and of generating described above and/or below.

FIG. 3 shows a machine-readable storage medium 301.

A computer program 303 is stored on machine-readable storage medium 301, which comprises commands that prompt a computer when executing computer program 303 to implement a method according to the first aspect.

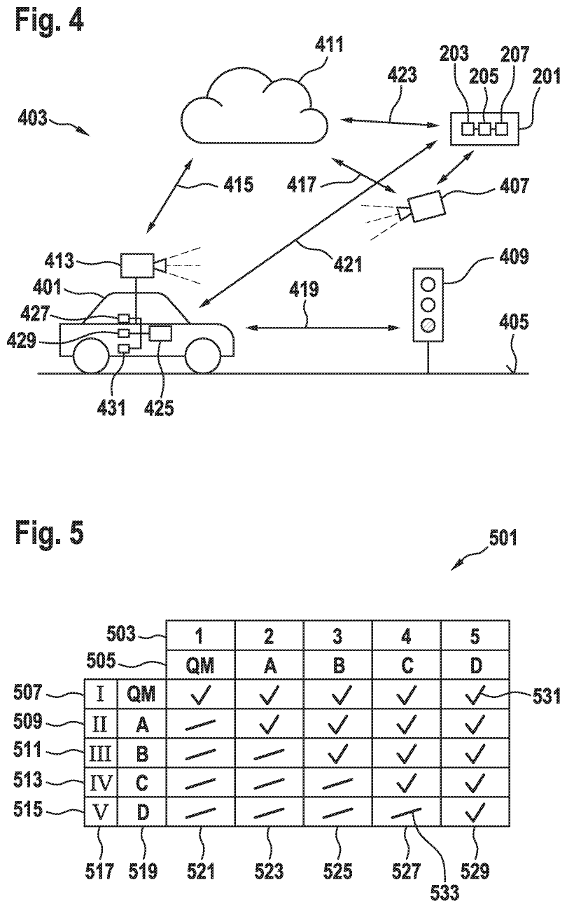

FIG. 4 shows a motor vehicle 401 traveling within an infrastructure 403 in accordance with an example embodiment of the present invention.

Infrastructure 403 comprises a road 405 on which motor vehicle 401 is traveling.

Infrastructure 403 further comprises a video camera 407 comprising a video sensor (not shown), a light signal system 409 as well as a cloud infrastructure 411, in which for example a device according to the second aspect may be situated and/or provided. Device 201 according to FIG. 2 is further shown by way of example, which is situated within infrastructure 403.

In a specific embodiment that is not shown, infrastructure 403 comprises multiple environment sensors, which are situated in a spatially distributed manner within the infrastructure.

The environment sensors of infrastructure 403 detect their respective environment and provide environment sensor data corresponding to the respective detection.

Environment sensor data are an example of infrastructure data.

In a specific embodiment that is not shown, infrastructure 403 has further traffic systems, for example signs, communication systems, in addition to or instead of light signal system 409.

Motor vehicle 401 comprises a roof-side video camera 413 comprising a video sensor (not shown).

In a specific embodiment that is not shown, motor vehicle 401 may have further environment sensors, in addition to or instead of video camera 413, which are situated for example on the front side and/or on the rear side and/or laterally on the motor vehicle.

FIG. 4 furthermore shows five double arrows 415, 417, 419, 421, 423. These symbolize a respective communication link or a respective communication channel between individual elements shown in FIG. 4.

Thus a first double arrow having reference numeral 415 symbolizes a communication link between motor vehicle 401 and cloud infrastructure 411.

A second double arrow having reference numeral 417 symbolizes a communication link between video camera 407 of infrastructure 403 and cloud infrastructure 411.

A third double arrow having reference numeral 419 symbolizes a communication link between motor vehicle 401 and light signal system 409. Via this communication link, the light signal system is able to transmit for example light signal image data as an example of infrastructure data to motor vehicle 401, the light signal image data representing a current and/or a future light signal image. Based on the light signal image data, it is possible for example to execute a driving function for driving motor vehicle 401 in at least partially automated fashion.

A fourth double arrow having reference numeral 421 symbolizes a communication link between motor vehicle 401 and device 201.

A fifth double arrow having reference numeral 423 symbolizes a communication link between device 201 and cloud infrastructure 411.

Motor vehicle 401 comprises a main control unit 425. Motor vehicle 401 may provide for example a first function 427, a second function 429 and a third function 431. Three squares are shown by way of example, which respectively symbolize one of the functions 427, 429, 431.

In a specific example embodiment that is not shown, fewer or more, for example 5, functions may be provided by motor vehicle 401.

The individual functions 427, 429, 431 may be executed for example by using, or based upon, the video data of video camera 413.

For the individual functions 427, 429, 431 to be permitted to use infrastructure data of infrastructure 403 in addition to or instead of the video data, it is a condition according to the concept described here that the totality made up of motor vehicle 401 and of elements involved in the method according to the first aspect are safe, that is, “SAFE” and “SECURE”.

The elements involved in the method according to the first aspect thus comprise presently in particular infrastructure 403 and motor vehicle 401 including its video camera 413 and main control unit 425 with the individual functions 427, 429, 431. According to the exemplary embodiment shown in FIG. 4, the elements of infrastructure 403 are cloud infrastructure 411, video camera 407, light signal system 409 and device 201.

The totality further includes also the respective communication link 415, 417, 419, 421, 423 between the corresponding elements.

This means in particular that for example a communication link 415 between motor vehicle 401 and cloud infrastructure 411 is checked to determine whether it is secure.

Accordingly, a check is performed for example to determine whether video camera 407 is secure.

As criteria for whether a communication link and/or an element of the totality is secure, the concept described here provides one or multiple safety conditions that must be fulfilled in order to be able to make the determination that the respective element and/or the respective communication link is secure.

For example, a communication link between two elements must have a minimum latency for the communication link to count as secure.

An environment sensor, for example, must fulfill certain quality criteria for it to count as secure.

An environment sensor data processing algorithm, for example, which in a device according to the second aspect is executed in cloud infrastructure 411 and/or in device 201, must meet certain quality requirements.

Specific emergency plans must be stored in cloud infrastructure 411 for example, so that the infrastructure data may be used for executing one of functions 427, 429, 431.

FIG. 5 shows an example table 501.

Seen from top to bottom relative to the paper plane, table 501 comprises a first row 503, as second row 505, a third row 507, a fourth row 509, a fifth row 511, a sixth row 513 and a seventh row 515.

Seen from left to right relative to the paper plane, table 501 further comprises a first column 517, a second column 519, a third column 521, a fourth column 523, a fifth column 525, a sixth column 527 and a seventh column 529.

Numbers 1 through 5, each of which stand for a different infrastructure, are entered in the individual cells of the table in first row 503.

Infrastructure 1 comprises for example an intersection. Infrastructure 2 comprises for example a freeway entrance. Infrastructure 3 comprises for example a traffic circle. Infrastructure 4 comprises for example a tunnel. Infrastructure 5 comprises for example a light signal system.

ASIL levels according to the ASIL classification, which infrastructures 1 through 5 respectively fulfill, are entered into the individual cells of the table in second row 505.

The abbreviation “ASIL” stands for “automotive safety integrity level.”

Regarding this classification, reference is made to the following documents:
https://de.wikipedia.org/wiki/ISO 26262
https://www.i-q.de/leistungen/iso-26262-fsm-und-fusi/fusi-asil-klassifikationen/
https://en.wikipedia.org/wiki/Automotive_Safety_Integrity_Level

Roman numerals I, II, III, IV and V, each of which stand for a function that may be provided by a motor vehicle, are entered in first column 517 from top to bottom in the respective cells of the table.

Function I may be an emergency braking function for example. Function II may be a driving function, for example, for driving the motor vehicle in at least partially automated fashion. Function III may be a lighting assistance function for example. Function IV may be a drive planning function for example. Function V may be an ESP function for example.

The individual ASIL levels according to the ASIL classification, which the associated functions I through V respectively fulfill, are entered in the second column 519 from top to bottom.

In the remaining cells of the table, check marks having reference numeral 531 indicate whether the combination of corresponding function and infrastructure on the basis of the ASIL levels allows for the corresponding function to be executed based on the infrastructure data of the corresponding infrastructure.

A slanted line in the respective cells of the table having reference numeral 533 indicates that the respective combination of function and infrastructure on the basis of the ASIL levels does not allow for the corresponding function based on the infrastructure data of the infrastructure to be executed.

Table 501 thus applies to a motor vehicle, that is, a specific motor vehicle, in different infrastructures for different functions.

A specific embodiment that is not shown (which is disclosed separately from the specific embodiment shown in FIG. 5) provides that, if it is determined that the infrastructure data may only be used in a limited manner, the function based on the infrastructure data may only be executed in a limited manner.

That the infrastructure data may only be used in a limited manner means, for example, that an ASIL level of the respective infrastructure is lower than a predetermined ASIL level and/or than the ASIL level of the function that is to be executed based on the infrastructure data. The predetermined ASIL level thus corresponds in particular to the ASIL level, which the infrastructure must fulfill so that the function based on the infrastructure data may be executed without limitation(s).

That the function based on the infrastructure data may only be executed in a limited manner may mean for example that the function based on the infrastructure data may only be executed up to a predetermined maximum motor vehicle speed. That is to say for example that the function based on the infrastructure data may only be executed up to a maximum motor vehicle speed of 50 km/h for example (limitation) instead of 120 km/h for example (without limitation).

That the function based on the infrastructure data may only be executed in a limited manner may mean for example that the function based on the infrastructure data may only be executed in certain weather, that is, for example only in dry weather (limitation) rather than also in rain (no limitation).

In summary, the present invention includes, inter alia, in particular on providing a concept that makes it possible to ensure that, in particular in motor vehicles that are driven in at least partially automated fashion, in particular self-driving motor vehicles, when using infrastructure data, only functions or actions are triggered and/or executed that are safe, that is, safe and secure.

Example embodiments of the present invention are based inter alia in particular on analyzing how safe, that is, safe and secure, are the individual systems, that is, the individual components, that is, for example the motor vehicle, infrastructure traffic systems, infrastructure sensors, infrastructure computer systems (local, cloud) and communication.

It is thus analyzed in particular how safe the entire system or the totality is with respect to the desired function. That is to say in particular that for a specific action or function in a specific motor vehicle in a specific infrastructure it is then ensured that the requirement for “safe” and “secure” is met for the respective function.

The at least one safety condition, that is, the requirement, is analyzed and defined in advance for example so that in particular it does not have to be additionally ascertained online.

One specific example embodiment of the present invention provides for the at least one safety condition to be continuously analyzed online and/or ascertained in particular within a specific area.

For this purpose, it is taken into account for example that the method is respectively implemented for a specific motor vehicle and/or a specific motor vehicle model and the desired infrastructure, for example at a specific freeway or at a specific intersection.

A reason for this is in particular that each motor vehicle and each infrastructure may have different components. That is to say in particular that a new check must be performed every time to determine whether the at least one safety condition is fulfilled for the specific infrastructure and/or for the specific motor vehicle. Even if standards existed for example, it is necessary to check current limitations, malfunctions and/or influences that disprove premises for example.

Thus, in order to be permitted to execute a function based on infrastructure data and/or to trigger or activate such a function, the requirements of the individual systems and of the overall system must suffice. For example, the individual systems and/or components and the overall system must exhibit a specific ASIL level according to the ASIL classification, for example ASIL-B.

One specific example embodiment of the present invention provides for the step(s) of checking to be re-checked subsequently, that is, at a later point in time, for example regularly. For example, the step(s) of checking is/are re-checked subsequently at a predetermined frequency, for example every 100 ms.

This re-checking, that is, the re-checking to determine whether the at least one safety condition is fulfilled, occurs according to one specific embodiment prior to and/or after and/or during one or several predetermined method steps.

According to one specific example embodiment of the present invention, the re-checking is performed or executed in the event of problems.

In summary, the present invention described herein includes ascertaining, prior to activating a function, that is, prior to using the function or executing the function, based on infrastructure data, that is, on data provided by an infrastructure, whether the individual elements and/or components, which are involved in the method and/or that were used for ascertaining the infrastructure data, fulfill specific safety requirements or safety conditions.

1. A method for the secure execution of a function provided by a motor vehicle, comprising the following steps:
receiving infrastructure data signals, which represent infrastructure data for the function provided by the motor vehicle;
receiving safety condition signals, which represent at least one safety condition that must be fulfilled so that the function may be executed based on the infrastructure data;
checking whether the at least one safety condition is fulfilled;
ascertaining, based on a result of the check, whether the function may be executed based on the infrastructure data;
generating result signals, which represent a result of the ascertainment; and
outputting the generated result signals.

2. The method as recited in claim 1, wherein the at least one safety condition is respectively an element selected from the following group of safety conditions:
(i) existence of a predefined safety integrity level or automotive safety integrity level of at least the motor vehicle and the infrastructure, including a communication link and/or communication components with respect to overall systems in the motor vehicle and infrastructure and components;
(ii) existence of a maximum latency of a communication between the motor vehicle and the infrastructure;
(iii) existence of a predetermined computer protection level of a device for performing the steps of the method;
(iv) existence of predetermined components and/or algorithms and/or communication options that are used for performing the steps of the method;
(v) existence of a redundancy and/or diversity in the predetermined components and/or algorithms and/or communication options that are used for performing the steps of the method;
(vi) existence of predetermined availability information, which indicates an availability of the predetermined components and/or algorithms and/or communication options;
(vii) existence of predetermined quality criteria of the predetermined components and/or algorithms and/or communication options;
(viii) existence of a plan which includes measures for reducing errors and/or measures in an event of failures of the predetermined components and/or algorithms and/or communication options and/or measures for misdiagnoses and/or measures in the event of misinterpretations;
(ix) existence of one or multiple fallback scenarios;
(x) existence of a predetermined function;
(xi) existence of a predetermined traffic situation;
(xii) existence of a predetermined weather;
(xiii) a maximally possible time for a respective implementation and/or execution of a step or of multiple steps of the method;
(xiv) existence of a result of a check to determine that elements and/or functions, which are used for carrying out the method, currently function in a faultless manner.

3. The method as recited in claim 2, wherein the at least one safety condition is selected as a function of a currently existing situation and/or as a function of a motor vehicle model and/or as a function of a motor vehicle type of the motor vehicle and/or as a function of an infrastructure model and/or as a function of an infrastructure type of the infrastructure and/or as a function of the function provided by the motor vehicle.

4. The method as recited in claim 1, wherein the ascertaining is performed as a function of a currently existing situation and/or as a function of a motor vehicle model and/or of a motor vehicle type of the motor vehicle and/or as a function of an infrastructure model of the infrastructure and/or as a function of an infrastructure type of the infrastructure and/or as a function of the function provided by the motor vehicle.

5. The method as recited in claim 1, wherein when the result indicates that the function may be executed based on the infrastructure data, the execution of the function based on the infrastructure data is monitored in that the steps of checking, of ascertaining and of outputting the generated result signals are performed anew, the function being executed further as a function of a newly ascertained result.

6. The method as recited in claim 1, wherein one step or multiple steps of the method steps are performed within the motor vehicle and/or one step or multiple steps of the method steps are performed outside the motor vehicle in the infrastructure.

7. The method as recited in claim 6, wherein the infrastructure is a cloud infrastructure.

8. The method as recited in claim 1, wherein one step or multiple steps of the method steps are documented in a blockchain.

9. The method as recited in claim 1, wherein a check is performed to determine whether a totality made up of the motor vehicle and of the infrastructure including a communication between the infrastructure and the motor vehicle is secure so that the motor vehicle and/or a local infrastructure and/or a global infrastructure and/or a communication between the motor vehicle and the infrastructure are checked.

10. The method as recited in claim 1, wherein the function is an element selected from the following group of functions: (i) an emergency braking function, (ii) a driving function for driving the motor vehicle in at least partially automated fashion, (iii) a lighting assistance function including a high-beam assistance function, (iv) an ESP function, (v) an ABS function, (vi) an air bag function, (vii) a drive planning function, (viii) a traffic analysis function, (ix) a brake function, (x) a drive function, (xi) a motor function, (xii) a steering function.

11. The method as recited in claim 1, wherein the infrastructure data include one or several elements selected from the following group of data: (i) environment sensor data of an infrastructure environment sensor, (ii) surroundings data, which represent a surroundings of the motor vehicle, (iii) weather data, which represent a weather in a surroundings of the motor vehicle, (iv) traffic data, which represent a traffic in a surroundings of the motor vehicle, (v) hazard data, which represent a location and/or a type of a hazard area in the surroundings of the motor vehicle, (vi) road user state data, which represent a state of a road user in the surroundings of the motor vehicle.

12. A device for the secure execution of a function provided by a motor vehicle, the device configured to:
receive infrastructure data signals, which represent infrastructure data for the function provided by the motor vehicle;
receive safety condition signals, which represent at least one safety condition that must be fulfilled so that the function may be executed based on the infrastructure data;
check whether the at least one safety condition is fulfilled;
ascertain, based on a result of check, whether the function may be executed based on the infrastructure data;
generate result signals, which represent a result of the ascertainment; and
output the generated result signals.

13. A non-transitory machine-readable storage medium on which is stored a computer program for secure execution of a function provided by a motor vehicle, comprising the following steps:
receiving infrastructure data signals, which represent infrastructure data for the function provided by the motor vehicle;
receiving safety condition signals, which represent at least one safety condition that must be fulfilled so that the function may be executed based on the infrastructure data;
checking whether the at least one safety condition is fulfilled;
ascertaining, based on a result of the check, whether the function may be executed based on the infrastructure data;
generating result signals, which represent a result of the ascertainment; and
outputting the generated result signals.
